(19) United States
(12) Patent Application Publication
(10) Pub. No.: US 2008/0070036 A1
(43) Pub. Date: Mar. 20, 2008

(54) METHOD FOR THE MANUFACTURE OF ROD-SHAPED COMPONENTS

(75) Inventors: Dieter Eisenhardt, Calw (DE); Stephanie Hoffmann, Wannweil (DE)

Correspondence Address: LEYDIG VOIT & MAYER, LTD, 700 THIRTEENTH ST. NW, SUITE 300, WASHINGTON, DC, 20005-3960, US

(73) Assignee: ENSINGER KUNSTSTOFFTECHNOLOGIE GBR, Nufringen (DE)

(21) Appl. No.: 11/854,569

(22) Filed: Sep. 13, 2007

(30) Foreign Application Priority Data
Sep. 18, 2006 (DE) 10 2006 045 736.6

(51) Int. Cl. B29C 57/00; B28B 11/00

(52) U.S. Cl. 428/399; 264/296; 425/392

(57) ABSTRACT

To provide a method for the manufacture of rod-shaped components with one or more functional elements from a thermoplastic resin material, the length of the rod-shaped components being optionally variable, it is proposed that the method comprise the steps of producing in an extrusion process a blank having dimensions corresponding substantially to the rod-shaped component, and reshaping a portion of the blank to create a prescribed cross-sectional change by means of agglomeration of material in this portion, thereby to form the component with a functional element, the portion being heated prior to or during the reshaping to a reshaping temperature lying between the glass transition point and the melting point or softening point of the resin material.

### CROSS-REFERENCE TO RELATED APPLICATIONS

The present disclosure claims the benefit of German application number 10 2006 045 736.6 of Sep. 18, 2006, which is incorporated herein by reference in its entirety and for all purposes.

### BACKGROUND OF THE INVENTION

The invention relates to a method for the manufacture of rod-shaped components from a thermoplastic resin material.

Rod-shaped components made from thermoplastic resin material are used in a large number of applications, in particular, as joint pin and the like, the rod-shaped components having functional elements, which necessitate an agglomeration of material, and comprise, for example, a head formed at their free end, and/or snap-in projections in the area between their ends.

Such rod-shaped components with functional elements are usually manufactured in an injection molding process, however, a change in the rod length requires a very expensive new tool to be made. Therefore, the changeover to production of a different length not only involves great expense, but also entails a considerable time requirement.

From a certain length of the rod-shaped component onwards, in particular, at lengths exceeding 1 m, the injection molding process reaches its limitations, and the material quality of the injection-molded part suffers.

Furthermore, all injection-molded parts have seams, which result from the tool being necessarily divided, and, in particular, when the rod-shaped components are used as joint pins, are disadvantageous because the desired perfectly cylindrical geometry is then not achieved.

The object underlying the present invention is to provide a method with which rod-shaped components having one or more functional elements can be manufactured from a thermoplastic resin material, and with which the length of the rod-shaped components can be optionally varied.

### BRIEF SUMMARY OF THE INVENTION

This object is accomplished, in accordance with the invention, with a method of the kind described at the outset, in that a rod-shaped blank having dimensions corresponding substantially to the rod-shaped component is first produced in an extrusion process, and the blank is then formed into a component with a functional element by reshaping a portion and thereby creating an agglomeration of material. Herein, the portion is heated prior to or during the reshaping to a reshaping temperature, which is selected between the glass transition temperature and the melting temperature or softening temperature of the resin material.

One or more prescribed portions of the blank can be reshaped, i.e., provided with one or more functional elements, with the method according to the invention, without the quality of the thermoplastic resin material thereby being impaired.

During the reshaping, a head, for example, can be formed at the free end of the blank, and/or projections, knobs or circumferential ring collars can be formed at an optional spacing from the ends of the blank. The cross-sectional changes created by means of an agglomeration of material on the blank can also have undercuts, viewed in axial direction, so that such components are very well suited for use in snap-in connections.

A great advantage of the method according to the invention is that the blank can first be obtained completely burr-free in an extrusion process, and that during the subsequent reshaping a cross-sectional change by means of an agglomeration of material is achieved free of cracks, without a thermal degradation or even an oxidation on the surface of the thermoplastic resin material having to be feared as a result. Furthermore, the mechanical values of the resin material are not impaired.

The mechanical characteristics of the resin material are thus also precisely prescribable in the portions affected by the reshaping, i.e., in the functional elements formed.

The tool costs incurred by the injection molding are many times higher than the tool costs involved in the method according to the invention, and, in particular, rod-shaped components of optional length can be manufactured with consistent quality.

The blanks are preferably cut to length from an extruded endless material and subsequently subjected to the reshaping process.

The reshaping temperature preferably lies at least 20° C. above the glass transition temperature of the thermoplastic resin material. Further preferred is the maintenance of a spacing of 35° C. from the glass transition temperature, whereby the deformation forces required for the reshaping can be further reduced.

The agglomeration of material in the reshaping according to the invention is created with a “cold flowing” of the resin material, so to speak, and very short holding times in the tool are possible.

This allows very high clock rates in the production, which constitutes a further advantage of the method according to the invention.

Owing to the relatively low temperatures required for the reshaping temperature, the energy costs involved in the method according to the invention are also low.

In the case of thermoplastic resin materials with a glass transition temperature above room temperature, the reshaping temperature will preferably range from approximately 35 to approximately 70° C. above the glass transition temperature.

On the one hand, this guarantees the possibility of reshaping without the expenditure of all too great forces for bringing about the agglomeration of material and cross-sectional change, i.e., the formation of the functional elements, and, on the other hand, with a reshaping temperature in this range a very large spacing is maintained from the melting temperature of all standard materials which, in particular, lend themselves as thermoplastic resin materials for the method according to the invention.

In particular, it is preferred for the reshaping temperature to lie at least 100° C. below the melting temperature, which, with the short holding times required in the method according to the invention, gives a guarantee for a minimal thermal stress on the thermoplastic resin material.

In accordance with the invention, the blank is fixed, for the reshaping step, in an area adjacent to the portion of the blank that is to be reshaped, in a tool without any substantial change in shape, while the portion that is to be reshaped is subjected to the reshaping.

In particular, the reshaping is carried out in the form of a swaging step, as it is known in analogy from metalworking.

In the swaging step, a compressing of the portion that is to be reshaped is preferably carried out parallel to the longitudinal direction of the blank.

For fixing the blank adjacent to the portion that is to be reshaped, a jaw chuck is preferably used, in particular, a three-Jaw chuck, which simultaneously serves to center the blank in the tool. As mentioned hereinabove, the portion that is to be reshaped can comprise a free end of the blank or rod-shaped component, and the reshaping can take place not only at one portion, but at several portions of the blank.

The portion that is to be reshaped can also be spaced from both ends of the blank.

A shaping tool is preferably used for the reshaping, so that the agglomeration of material specifically results in the desired shape of the functional element of the finished component.

A swage, for example, is suitable as shaping tool.

Supplementarily or alternatively thereto, shaping tools which are separable for release of the component can also be used, so that, in particular, agglomerations of material can be produced at a spacing from the free ends.

Owing to the fact that reshaping temperatures that lie far below the melting temperature or softening temperature of the resin material can be worked with in the method according to the invention, the formation of burrs is avoided in the reshaping step, even when separable tools are used therefor.

As mentioned hereinabove, the holding times of the blanks in the tool used in the method according to the invention are low. A low holding time is understood as holding times of less than 15 min, which in many cases can be considerably lower, for example, 10 sec, and are already sufficient to make the reshaping or the agglomeration of material irreversible.

In many cases, holding times ranging from 30 sec to 5 min are adequate.

The heating-up of the portion of the blank to the reshaping temperature for the reshaping can be carried out in many different ways. Firstly, it is possible to raise this portion to the reshaping temperature prior to introducing the blank into the reshaping tool. In this case, the reshaping tool can be heated or unheated.

It is, however, easier to heat the portion to the reshaping temperature in the shaping tool.

It is further preferred to keep the portion at the reshaping temperature during the holding time.

It is further preferred, since it involves less regulating expenditure, for the tool to be kept constantly at the reshaping temperature, and, when inserting the blank and subsequently fixing it, for the stored heat to be transferred to the resin blank.

Owing to the low reshaping temperatures of the method according to the invention, the cooling-down of the shaping tool or the reshaped blank can be dispensed with. The release temperatures in injection molding processes with comparable materials lie in the range of the reshaping temperatures used in accordance with the invention.

In accordance with a variant of the method according to the invention, a portion of the tool for fixing the blank can be heated and thus form a portion in which a, where required, further reshaping process, i.e., a “cold flowing” of the resin material with an agglomeration of material, is subsequently possible.

As discussed hereinabove, an endlessly produced, rod-shaped material is preferably produced, from which the blank is then cut to length in accordance with the length required for the rod-shaped component.

The rod-shaped materials can thus be produced as supply of endless material, and, as required, blanks are then cut to length from the endless supply and worked in a reshaping step into the finished rod-shaped component.

In principle, there are no limitations for the cross section of the rod-shaped components, i.e., optional cross sections in the rod-shaped materials transversely to the longitudinal direction are possible.

Symmetrical geometries are, however, often required, in particular, cylindrical geometries such as, for example, in joint pins.

The invention further relates to components made from a thermoplastic resin material, comprising a rod-shaped extruded main body with a substantially constant cross section and at least one portion of differing cross section formed by agglomeration of material.

The difference in cross section formed by agglomeration of material can vary very widely in shape and assume, for example, a spherical cap shape at the end of a component, or, for example, the shape of a ring collar at a spacing from an end of the component. The shape of the functional element can thus be adapted to its function.

In the same way, projections can be formed as functional elements around the outer circumference of the component, in particular, also projections extending right around, and undercuts can be made in these projections as well as in the spherical cap shapes at the end of a component.

The components according to the invention are suited, in particular, for use as joint pins, and one of the preferred fields of application relates to use in chain belts which are widely employed in industrial transport processes. In some cases, the band widths of the chain belts are of considerable size and in many cases exceed the width of 1 m. Here the required length of the joint pins is prescribed by the width of the chain belts, as a joint pin has, as far as possible, to establish the joint connection over the entire width of the belt, in order to avoid weak spots in the belt.

The rod-shaped components of the present invention can be used with particular advantage in chain belts which are employed in the field of food production, for example, in freezing or baking production lines. Owing to the gentle method for the reshaping, the mechanical and chemical properties of the thermoplastic resin materials remain unaffected, so that a resin material that has once been approved for this sector does not have to undergo renewed testing and can be employed without hesitation in the production of foods.

Although the rod-shaped components of the present invention will, as a rule, consist of a solid material, it is, of course, conceivable for rod-shaped components having, for example, a longitudinal channel located inside them to be used in special configurations.

A tool comprising, firstly, a fixing tool for holding the component in an area adjacent to the portion that is to be reshaped, and, secondly, a reshaping tool itself, is preferably used for performing the method according to the invention. The reshaping tool is held so as to be movable relative to the fixing tool and is preferably provided with a heating device.

The fixing tool is preferably configured as a three-jaw or four-jaw chuck, which, in addition to the fixing, can also simultaneously carry out a centering of the blank that is to be reshaped.

The jaws of the fixing tool can be separated, viewed in axial direction of the blank, and a portion of the jaws can be heated.

The reshaping tool is also preferably centered by the jaws of the fixing tool, so that a very precise creation of the changed cross section can be carried out on the rod-shaped component, without the necessity for complicated adjustments to the tool.

For example, the jaws can be moved in a radial direction towards and away from the rod-shaped blank, and portions of the jaws can form a guide for a cylindrical component and also center the latter by the reshaping tool being held so as to be displaceable relative to the fixing tool.

While an adequate centering of the blank in the tool is achieved with the three-jaw chuck, the four-jaw chuck has the advantage that it reacts in a geometrically neutral manner in the event of a thermal expansion.

These and further advantages of the invention will be explained in greater detail hereinbelow with reference to the drawings.

### BRIEF DESCRIPTION OF THE SEVERAL VIEWS OF THE DRAWINGS

FIG. 1 shows a perspective representation of a component according to the invention;

FIG. 2 shows a sectional view taken on longitudinal line II-II in FIG. 1;

FIG. 3 shows a sectional view through a further component according to the invention;

FIG. 4 shows a sectional view through a further component according to the invention;

FIG. 5 shows a perspective representation of part of a component according to the invention;

FIG. 6 shows a chain belt with a joint pin in the form of a component according to the invention;

FIG. 7 shows a tool according to the invention for performing the manufacturing method according to the invention; and

FIG. 8 shows a detail from and variant of a tool according to the invention in accordance with FIG. 7.

### DETAILED DESCRIPTION OF THE INVENTION

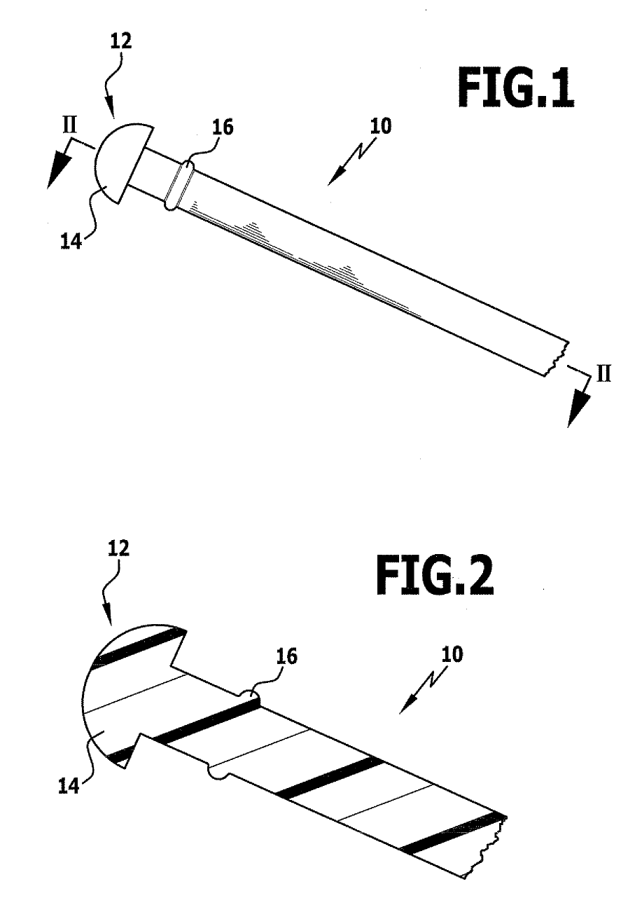

FIG. 1 shows a rod-shaped component according to the invention, generally designated by reference numeral 10, in the form of a joint pin with a substantially cylindrical shape. At one free end 12, the joint pin 10 has a spherical cap-shaped head 14, which was formed by reshaping a cylindrical blank in accordance with the method according to the invention. In this example, the diameter of the cylindrical blank is 3 mm.

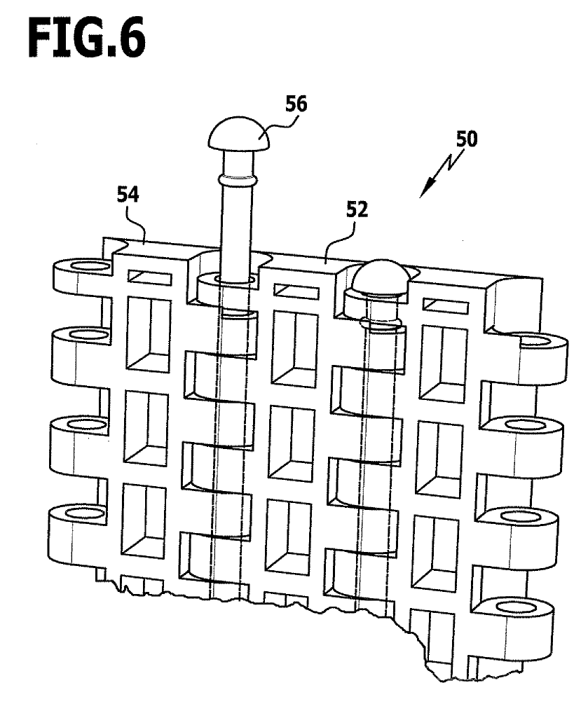

A ring collar 16 serving to lock the joint pin upon insertion into an associated joint connection (cf. FIG. 6) is formed at a spacing from the head 14 on the joint pin 10.

In the present case, the joint pin is made from a polyamide 6.6 material, which has a melting temperature of approximately 260° C.±5° C. The glass transition point in this material usually lies at approximately 70° C. to 50° C., depending on the moisture content of the material used.

The ideal working temperature here for the reshaping process lies above 110° C., in particular, in the range of 120 to 140° C., at which the reshaping step can be carried out without too great an expenditure of force.

Polyamide (PA) 6.6 shows a thermal, oxidative degradation only under extreme long-term exposure to temperatures above 140° C., where long-term exposure is to be understood as exposure over several days.

Since the holding time of the blank during and after the reshaping process can be limited to approximately 30 sec or even less (in dependence upon the diameter of the joint pin 10) it will be clear that the reshaping conditions in accordance with the method according to the invention are very remote from conditions under which thermal and oxidative degradation reactions are usually observed in the resin material PA 6.6. Only at temperatures of 220° C. are thermal and oxidative degradation reactions observed at holding times of longer than 1 h.

The expenditure of force for the described reshaping and formation of the functional elements 14 and 16 lies in the case of a blank having a diameter of 3 mm at approximately 40 to 200 MPa.

Very many different resin materials can, of course, be used for the manufacture of the joint pin 10, in particular, also such in which the glass transition temperature lies much lower than in the PA 6.6 discussed hereinabove.

Materials such as PA 11 and PA 12 are, for example, suitable. PA 11 has a glass transition temperature of approximately 43 C and a melting temperature of approximately 183° C. PA 12 has a glass transition temperature of approximately 45° C. and a melting temperature of approximately 175° C. The processing temperatures in conventional methods, at which the polymers are melted, lie at approximately 190 to 210° C. for both PA polymers.

A further material which demonstrates the range of materials that can be processed with the method according to the invention is polyoxymethylene (POM), which has a melting temperature of approximately 200° C., with a glass transition temperature which lies significantly under 0° C., namely at approximately −60 C.

In the case of such a material, that partial area or portion of the blank at which the reshaping or the formation of the functional element is to take place is determined by heating the portion of the blank that is to be reshaped to a temperature above room temperature. In principle, the reshaping could, of course, take place here without any heating to a temperature above room temperature, but there is then the problem that a change in the shape of the blank may also occur in the fixing tool and, in this case, the blank will then lose its previous perfectly cylindrical shape.

If, on the other hand, such materials with very low glass transition temperatures are heated in the area that is to be reshaped to a temperature significantly above room temperature, for example, to a temperature of 50° C., the reshaping process can then be limited very precisely to the heated portion of the blank.

Typical diameters of the rod-shaped components according to the invention range from 2 mm to 10 mm.

FIG. 2 shows a sectional representation of the joint pin of FIG. 1. Here it is to be noted that the spacing of the annular collar 16 from the head 14 is relatively short in this case, so that both cross-sectional changes can be carried out in one reshaping step.

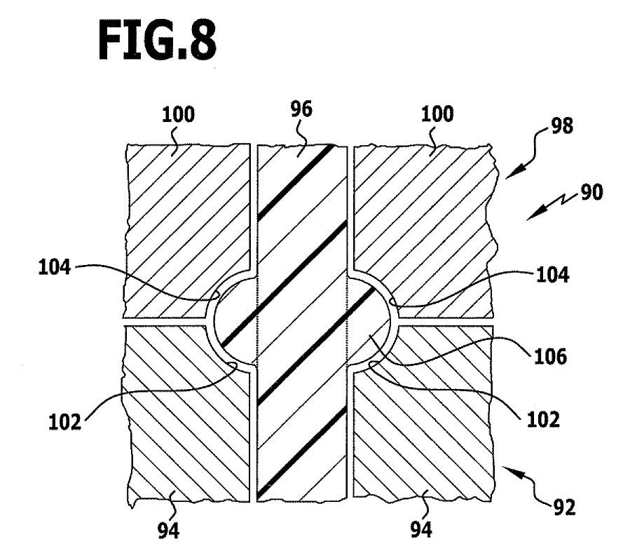

If an annular collar is desired as further functional element at a location spaced further from the head 14, this can also be accomplished in accordance with the invention, but this is then preferably performed in a separate reshaping step. This will be gone into in further detail hereinbelow in connection with the description of FIG. 8.

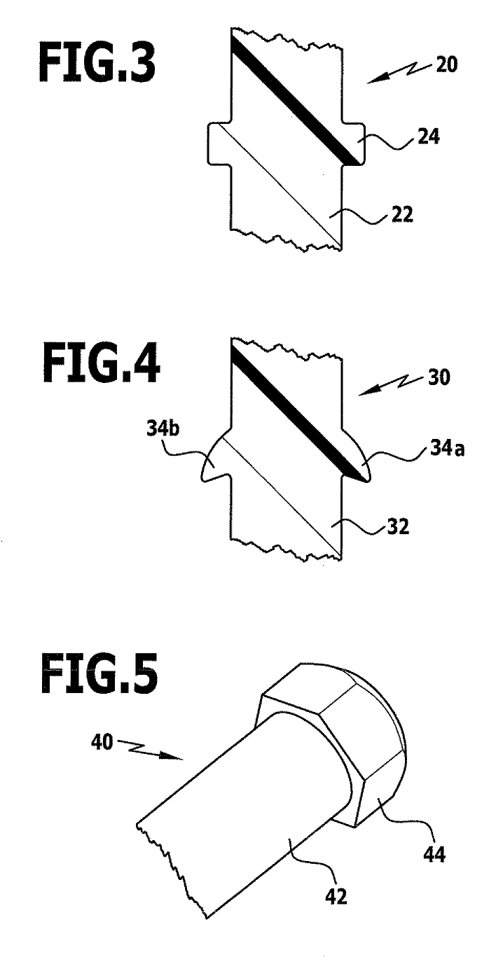

FIG. 3 shows a section of a component 20 according to the invention with a cylindrical main body 22 on which a ring collar 24 of rectangular cross section is formed as functional element.

FIG. 4 shows a component 30 according to the invention with a substantially cylindrical main body 32 and slightly undercut projections 34 formed on the latter as functional element.

FIG. 5 shows a further variant of a component 40 according to the invention with a cylindrical main body 42 and a hexagon 44 formed on the free end of the component 40 as functional element.

FIG. 6 shows a section of a chain belt 50, as used in industrial food production methods. Here individual chain links 52, 54 are joined in an articulated manner by a joint pin 56. Depending on the width of the chain belt, a corresponding length is required for the joint pin 56, so that the latter extends through the entire chain belt in its width. By means of the functional elements of the joint pin 56, an exact positioning and a fixing thereof in its axial direction relative to the chain links is achieved.

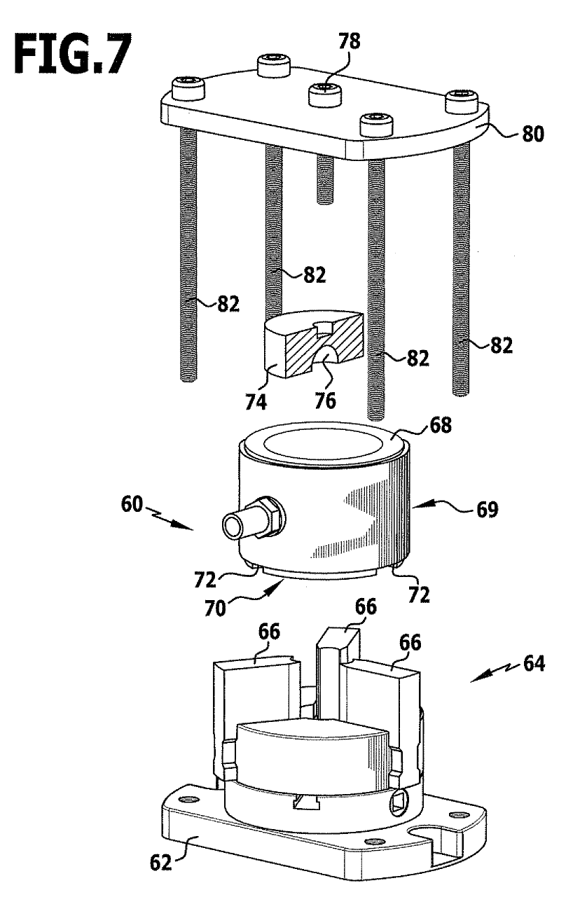

FIG. 7 shows an apparatus, generally designated by reference numeral 60, which serves to perform the method according to the invention, and which itself constitutes part of the present invention.

The apparatus comprises a three-jaw chuck 64, which is mounted on a base plate 62, and through the center of which a continuous bore (not shown) extends, in which a rod-shaped blank can be received for manufacture of a rod-shaped component according to the invention.

The three-jaw chuck 64 comprises three radially displaceable jaws 66, which can be synchronously displaced in radial direction inwardly and outwardly, respectively.

In the assembled state, a guide ring 68 is supported on the three jaws 66 of the three-jaw chuck 64. At its end face 70 that faces the jaws 66, the guide ring 68 has three grooves 72 in which the jaws 66 slidingly engage.

A centering of the guide ring 68 relative to the center of the position defined by the three-jaw chuck for the fixed blank is thereby prescribed.

In the guide ring 68 there is axially displaceably held a swage plate 74 having a central cutout 76 which functions as negative mold for the formation of a spherical cap-shaped head on the blank that is to be processed.

Once the blank has been introduced into the three-jaw chuck and clamped in a centered manner by the latter, the blank can be heated (heating jacket 69) in the portion that is to be reshaped by the guide ring 68, which constitutes part of the reshaping tool, and once the blank has reached the reshaping temperature in this portion, the swage plate 74 is then displaced in axial direction against the jaw chuck 64, in the example shown here by means of a feed screw 78, which is received in a thread by an assembly plate 80. The assembly plate 80 is connected via tension rods 82 to the base plate 62, so that the force exerted by the feed screw 78 results in a compression of the portion of the blank raised to reshaping temperature.

If recesses (cf. description of FIG. 8) are formed in the upper area of the jaws 66, then, in addition to the head element, a ring collar, for example, can also be simultaneously formed on the blank in a manner similar to that shown in the embodiment of FIG. 1.

For release of the component, the pressure of the feed screw 78 is first taken away and the jaw chuck opened, whereupon the finished component can then be removed from the apparatus.

As is clearly apparent from the drawing of FIG. 7 and the foregoing description, the tool according to the invention can be of very compact and low-weight construction, so that, for example, a service employee in charge of servicing the chain belts in use at the customers' premises can take it along with him and can then cut to length the necessary joint pin replacement, possibly from an endless material, and form the corresponding functional elements with the above-described tool according to the invention on the blank in situ.

The method according to the invention and the tool according to the invention also allow, in case of doubt, emergency repairs where, for example, in the case of breakage of a joint pin, only a portion of the latter needs to be replaced, which can then be inserted from the direction opposite to the still functioning remainder into and fixed in the joint of the chain belt.

In the description of the foregoing tool, a jaw chuck was used to fix the blank in the apparatus and to then cause the agglomeration of material in the portion to be reshaped using a reshaping tool in the form of a swage, thereby forming the desired functional elements.

This is achieved in the above-described manner at the free ends of the blank. If, however, a functional element is to be produced at a spacing from the ends of the blank, it is recommended that the reshaping tool be modified as shown schematically in FIG. 8.

The apparatus in FIG. 8, designated by reference numeral 90, is essentially constructed in the same manner as the apparatus described in conjunction with FIG. 7. First of all, the apparatus comprises a three-jaw chuck 92 with jaws 94 which, in the fixed position, hold a blank 96 centered in the apparatus.

Differently from the apparatus according to FIG. 7, the reshaping tool here is a jaw chuck 98 with jaws 100, which receive in a centered manner and also fix the part of the blank 96 that projects out of the jaw chuck 92. The blank 96 is raised to reshaping temperature in the area between the two jaw chucks 92 and 98, and the two jaw chucks 92 and 98 are then moved relative to each other, so that a compression of the blank 96 takes place with agglomeration of material in the area prescribed by cutouts 102, 104 in the jaws 94, 100. There is thereby formed on the blank 96 at the portion to be reshaped, which, as indicated by dotted lines in FIG. 8, has a cylindrical shape, a ring collar 106, as is also apparent from FIG. 8, due to agglomeration of material as a result of compressing the blank 96.

It will be clear from this description that with the method according to the invention and the apparatus according to the invention, functional elements can be formed at any point on rod-shaped components of any length, a process which can, of course, also be performed a number of times on a blank 96.

The only precondition, in this connection, is that the jaw chucks provide a corresponding recess for functional elements that have already been formed or that the jaw chucks be of such dimensions in their axial extent that they avoid contact with functional elements already formed on the blank/rod-shaped component.

It will also be understood that as for the apparatus shown in and described in conjunction with FIG. 7, the jaws of the fixing tool, and, in this case, also of the reshaping tool, must be displaceable so far apart that the finished component with the functional elements formed thereon can be removed from the apparatus through the jaw. The bores in the base plate 62 and the assembly plate 80 (applied to the structure in FIG. 7) must then be of correspondingly large dimensions.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A Method for the manufacture of rod-shaped components from a thermoplastic resin material, comprising:
producing in an extrusion process a blank having dimensions corresponding substantially to the rod-shaped component, and
reshaping a portion of the blank to create a prescribed change in cross section by agglomerating material in this portion, to form the component with a functional element,
wherein the portion is heated prior to or during the reshaping to a reshaping temperature between the glass transition temperature and the melting temperature or softening temperature of the resin material.

2. The method in accordance with claim 1, wherein the reshaping temperature lies at least 20° C. above the glass transition temperature.

3. The method in accordance with claim 2, wherein the reshaping temperature lies at least 35 to 70 C above the glass transition temperature.

4. The method in accordance with claim 1, wherein the reshaping temperature lies at least 100 C below the melting temperature.

5. The method in accordance with claim 1, wherein the blank is fixed in an area thereof adjacent to the portion that is to be reshaped in a tool without undergoing any substantial change in shape, while the portion that is to be reshaped is subjected to the reshaping.

6. The method in accordance with claim 5, wherein the reshaping is performed as swaging.

7. The method in accordance with claim 6, wherein the swaging step comprises compressing the portion parallel to the longitudinal direction of the blank.

8. The method in accordance with claim 5, comprising fixing the blank in a jaw chuck of the tool.

9-10. (canceled)

11. The method in accordance with claim 1, wherein the portion that is to be reshaped comprises a free end of the blank.

12. The method in accordance with claim 1, wherein the portion that is to be reshaped is spaced from both ends of the blank.

13-15. (canceled)

16. The method in accordance with claim 1, wherein the blank is held in a shaping tool for at least 10 s.

17. (canceled)

18. The method in accordance with claim 16, wherein the portion is heated in the shaping tool to the reshaping temperature.

19. The method in accordance with claim 18, wherein the portion is kept at the reshaping temperature during the holding time.

20. The method in accordance with claim 18, wherein the shaping tool is kept permanently at the reshaping temperature.

21. The method in accordance with claim 18, wherein a portion of the fixing tool adjacent to the reshaping tool is heated.

22. The method in accordance with claim 1, wherein the blank is heated to the reshaping temperature prior to insertion into a reshaping tool.

23. The method in accordance with claim 22, wherein the reshaping tool is unheated.

24. The method in accordance with claim 1, comprising, obtaining a preform from an endlessly produced, rod-shaped material in a fabrication step before producing the blank.

25. A component made from a thermoplastic resin material, comprising a rod-shaped main body of substantially constant cross section and at least one portion of differing cross section.

26. The component in accordance with claim 25, wherein the at least one portion of differing cross section is arranged at a free end of the component.

27. The component in accordance with claim 25, wherein the at least one portion of differing cross section is spaced from both free ends of the component.

28. The component in accordance with claim 25, wherein the portion of differing cross section has the shape of a spherical cap.

29. The component in accordance with claim 25, wherein the portion of differing cross section has a polygonal shape.

30. The component in accordance with claim 25, wherein the portion of differing cross section has the shape of a ring collar.

31. The component in accordance with claim 25, wherein the portion of differing cross section has one or more radially protruding projections on its outer circumference.

32. An apparatus for manufacturing rod-shaped components from a thermoplastic material, comprising a fixing tool for fixing a rod-shaped blank, and a reshaping tool, the reshaping tool and the fixing tool being held in the apparatus for displacement relative to each other in axial direction of the blank.

33. The apparatus in accordance with claim 32, wherein the fixing tool comprises a centering device for centering the blank in the apparatus.

34. (canceled)

35. The apparatus in accordance with claim 34, wherein the jaws of the fixing tool are divided in axial direction of the blank, a portion of the jaw chuck that faces the reshaping tool being of heatable design.

36. The apparatus in accordance with claim 32, wherein the apparatus comprises a guide for the reshaping tool, in the form of a hollow cylinder.

37. The apparatus in accordance with claim 36, wherein the guide for the reshaping tool comprises guide elements, which cooperate with the fixing tool in such a way as to bring about a centering of the guide of the reshaping tool with respect to the symmetry of the axis of the fixing tool.

38-40. (canceled)

41. A chain belt comprising:
a plurality of joint pins and a plurality of individual links, wherein the individual links are joined by joint pins, the joint pins comprising a rod-shaped main body of substantially constant cross section and at least one portion of differing cross section, the joint pins being made from a thermoplastic resin material.
